(19) United States
(12) Patent Application Publication
(10) Pub. No.: US 2018/0343991 A1
(43) Pub. Date: Dec. 6, 2018

(54) Tool Holder

(71) Applicant: John J. Olson, Brainerd, MN (US)

(72) Inventor: John J. Olson, Brainerd, MN (US)

(21) Appl. No.: 15/684,655

(22) Filed: Aug. 23, 2017

Related U.S. Application Data
(60) Provisional application No. 62/378,672, filed on Aug. 23, 2016.

(51) Int. Cl. A44C 9/00; B25H 3/00; B25B 23/12; A45F 5/00

(52) U.S. Cl. CPC A44C 9/0061; A45F 5/00; B25B 23/12; B25H 3/003

(57) ABSTRACT

A generally annular tool holder is fabricated from a relatively soft and highly elastic hypo-allergenic silicone material. An annular band is configured to elastically encircle a thumb or other phalange. A tool receptacle body protrudes radially from the annular band. The tool receptacle body has a plurality of at least partial bores provided along an axis parallel to the central axis of the annulus that are configured to selectively receive and retain drill, driver, and other bits and tools. The bits are both visible and accessible to a drill operator even while the operator is holding the drill. One or more magnets may also be provided within the bores, extending the types of uses for the tool holder.

### CROSS REFERENCE TO RELATED APPLICATIONS

The present application claims the benefit of U.S. provisional patent application 62/378,672 filed Aug. 23, 2016 of like title and inventorship, the teachings and entire contents which are incorporated herein by reference.

### BACKGROUND OF THE INVENTION

### 1. Field of the Invention

The present invention pertains generally to the field of hand-held power tools, and more particularly to accessories that improve the ease of use of such tools.

### 2. Description of the Related Art

There are a wide variety of hand-held power tools that provide much utility. Exemplary among these are the variety of rotary tools including power drills, power screwdrivers, and the like. These rotary tools enable very rapid and secure fastening, boring, drilling, sanding, grinding, polishing, and many other diverse functions. For many projects, these diverse functions will be completed using a few different tools, requiring switching between a few of the various bits into and out of the chuck or other tool holder provided within the rotary tool.

To facilitate these tool changes, many manufacturers of these tools have provided tool-less chucks that enable a person with a quick twist of the chuck to release a presently held bit, allowing rapid change. This saves a person from needing to keep track of a chuck key or wrench. The demand for this convenience is great enough that, in spite of the increase in cost, most of these tools are provided with such chucks.

While the improved chucks provide much benefit, the bits themselves, which are generally quite small and easily misplaced, must still be removed from the chuck and stored until needed again. These bits are commonly provided in large organizers that may contain many similarly sized bits. Consequently, the tool operator must take the time to retrieve the bit holder and properly place the bit therein. In other words, while the improved chucks have reduced the burden on a tool operator by not having to handle and keep track of the chuck key, the operator must still keep track of all of the remaining bits that the operator wishes to use.

Since, as aforementioned, for most projects there are only a few bits that are required, rather than sorting these few bits from and back into a separate holder, most people will try to place the unused bit(s) on a work surface. Unfortunately, this can lead to accidental dropping of the bits such as by hitting the bits with another part, a cord, or other object. Particularly in the case of a drill bit this drop can damage the bit. Inevitably, there will be much wasted time trying to find and retrieve the accidentally dropped bits and bits that have been covered by sawdust or other tools, materials, or parts. In addition, a person may not always be standing next to a work bench when working on a project, and may instead find themselves in an awkward space such as on a ladder or under an automobile. In these cases, the person will not have easy access to a good bit storage receptacle. Consequently, there remains a need for a way to better handle the bits that a tool operator wishes to use frequently on a project.

Recognizing this need, a number of highly skilled artisans have developed different apparatus to assist with the handling of bits. Exemplary U.S. patents, the teachings which are incorporated herein by reference, include: U.S. Pat. No. 4,905,335 by Tervola, entitled “Magnetic rings, bracelets and necklaces”; U.S. Pat. No. 9,033,198 by Escherich, entitled “Magnetic bit-holder bracelet device”; and Des U.S. Pat. No. 371,945 by Geary et al, entitled “Drill bit holder”.

The Tervola patent describes in the preferred embodiment a ring that is fabricated from stainless steel that incorporates several different types of bits directly into the body of the ring. Other embodiments are disclosed that include the incorporation of a magnet. Nevertheless, this apparatus is not well suited to the retention of a plurality of bits or drivers. The magnetic coupling of ferromagnetic bits, which includes nearly all drill bits and drill bit screw drivers, will cause the bits to be attracted to each other and to other ferromagnetic objects. This means that the bits may be displaced easily or lost, through no fault of the wearer. Even when retained tightly to the ring, the bits can become entangled or tightly held together, making them much harder to select and use, simply by the magnetic forces drawing adjacent bits together. In addition, the use of a hard material such as stainless steel is very undesirable when working with power tools, hammers, and other work tools. This is because the ring is much stronger than adjacent flesh, and forces applied to any portion of the ring will be transmitted into the flesh. Since the ring with bits attached thereto will necessarily protrude farther than a person's associated body part, there is undesirable risk of harm or injury to the wearer.

The Escherich patent provides a bracelet that may be fabricated from a natural or synthetic rubber, has individual pockets to receive bits in, and further provides magnets at the base of the pockets to provide additional hold to retain the bits in. These pockets isolate the bits, reducing the chance of the bits being pulled into contact with each other. However, there still remains the possibility that the bits will stick through coupled magnetic field to an adjacent ferromagnetic object, and be removed from the pockets thereby. In addition, and in spite of the many benefits provided, the apparatus is relatively more complex to manufacture, requiring a plurality of sleeves in addition to the bracelet and magnets.

The Geary et al design patent illustrates a drill bit holder that has what appear to be a plurality of cylindrical through holes and an adjustable strap, presumably to form the enclosed annular geometry. However, the Geary et al construction uses a discontinuous junction between the adjustable strap and the bit holder region, which will create very undesirable stress within the material at this junction. Stress will lead to premature failure. In addition, the bit holder extends around a majority of the circumference, meaning this drill bit holder will not be useable as a thumb or finger holder, because the holder and bits would interfere with useful function. There is no disclosure of the materials used in the fabrication of the bit holder, nor any consideration for the provision of a magnetic tool holder.

Other artisans have developed different apparatus to assist with handling of sockets, nuts and bolts. Exemplary U.S. patents and published applications, the teachings which are incorporated herein by reference, include: U.S. Pat. No. 3,913,646 by Grayson, entitled “Fingertip nut and bolt holding tool”; 2004/0144216 by Risolio, entitled “Finger Wrench”; and 2010/0107827 by Miller, entitled “Fingertip Tool Holder”. Each of these patents and published applications are configured presumably to allow a person to manipulate tools when working in a small space, and so offer little more teaching of how to improve upon the teachings of Tervola, Escherich, and Geary et al described herein above.

There are also additional patents that illustrate holders for other diverse tools, such as writing implements and paint brushes. Exemplary U.S. patents and published applications, the teachings which are incorporated herein by reference, include: U.S. Pat. No. 1,286,610 by Harriman, entitled “Tool holder”; U.S. Pat. No. 6,249,277 by Varveris, entitled “Finger-mounted stylus for computer touch screen”; U.S. Pat. No. 6,540,421 by Porcelli, entitled “Leash for a writing implement”; U.S. Pat. No. 8,863,758 by Walenciak, entitled “Removable adaptive device for a clipper instrument”; 2006/0185057 by Terpinski, entitled “Magnet Finger Glove”; and 2007/0187446 by Marks, entitled “Implement Holder”; 2012/0170962 by Nwapa-Jourdan et al., entitled “Writing Instrument or Stylus Appendage for Attachment with a Finger”.

Additional patents and published applications of varying relevance, the relevant teachings and contents which are incorporated herein by reference, include: U.S. Pat. No. 1,094,888 by Ehrle, entitled “Pencil clip”; U.S. Pat. No. 1,879,489 by Ray, entitled “Writer's ring”; U.S. Pat. No. 2,491,860 by Ingraham, entitled “Magnetic nail holder”; U.S. Pat. No. 2,585,641 by Faso, entitled “Finger-supported tool for locating and turning small nuts, boltheads, etc.”; U.S. Pat. No. 3,075,498 by Udcoff, entitled “Finger holder for various articles”; U.S. Pat. No. 4,256,157 by Grayson, entitled “Nut, bolt, and screw holder”; U.S. Pat. No. 5,868,509 by Crutcher, entitled “Holder for a writing instrument”; U.S. Pat. No. 5,885,018 by Sato, entitled “Writing tool with a ring for mounting on a finger”; U.S. Pat. No. 6,328,494 by Moxon, entitled “Ergonomic tool holder or writing tool with means to be molded to fit the user's hand”; U.S. Pat. No. 6,481,114 by Kalajian, entitled “Finger ring shim and sizing tool”; U.S. Pat. No. 6,669,388 by Short, entitled “Finger-mounted marking device”; Des U.S. Pat. No. 604,140 by Whitehead, entitled “Tool holder”; Des U.S. Pat. No. 633,763 by Pengra, entitled “Wrench”; Des U.S. Pat. No. 678,415 by Gorbunov, entitled “Ergonomic implement holder”; 2001/0053306 by Schneider, entitled “Adjustable Finger Stylus”; 2004/0237261 by Rouse, entitled “Marking Tool”; 2006/0039739 by Komorowski, entitled “Stylus Holder”; 2006/0174448 by You, entitled “Pen-Holding Posture Corrective Apparatus”; 2008/0295255 by Whitehead, entitled “Tool Holder”; 2009/0279936 by Kuykendall, entitled “Function First Grip”; 2010/0288080 by Babusiaux, entitled “Bottle Opening Devise and Method for Making Same”; 2010/0289282 by Avery, Jr. et al., entitled “System for Attaching an Implement to a Person”; 2013/0180084 by Edson, entitled “Gripping Devise for Handles”; 2013/0322948 by Maddox, entitled “Writing Utensil Holding System”; 2014/0260814 by Bullard, entitled “Method and System for Holding Nails”; 2015/0255050 by Diaz Lopez, entitled “Holder for Switch of Instruments' Positions (Fast Pick)”; and 2015/0342328 by Seger, entitled “Ring Tool Holder”.

As may be apparent, in spite of the enormous advancements and substantial research and development that has been conducted, there still remains a need for an improved tool holder that is well adapted for use with diverse drill bits and other ferromagnetic and non-ferromagnetic tools.

In addition to the foregoing patents, Webster's New Universal Unabridged Dictionary, Second Edition copyright 1983, is incorporated herein by reference in entirety for the definitions of words and terms used herein.

### SUMMARY OF THE INVENTION

In a first manifestation, the invention is, in combination, a rotary driver, at least one rotary driver bit, and a tool holder. The rotary driver comprises a rotary drive engine, a switch to selective energize the rotary drive engine, and a rotary tool chuck configured to selectively couple and decouple the at least one rotary driver bit to the rotary driver. The tool holder comprises an interminable annular band defining an annular axis that is adapted to receive a thumb or finger therein. At least one tool receptacle body is affixed with and radially protrudes from the annular band. An opening passes through the at least one tool receptacle body in an axis generally parallel to an axis defined by the annular band and is configured to removably receive and retain the at least one rotary driver bit.

In a second manifestation, the invention is a tool holder. An interminable annular band defines an annular axis and is adapted to receive a thumb or finger therein. At least one tool receptacle body is affixed with and radially protrudes from the annular band. An opening passes through the at least one tool receptacle body in an axis generally parallel to an axis defined by the annular band and is configured to removably receive and retain a rotary driver bit.

In a third manifestation, the invention is a method of applying a ferromagnetic fastener to a work piece. The steps include inserting a phalange supported tool holder having a magnet affixed thereto into a plurality of ferromagnetic fasteners; removing the tool holder from the plurality of ferromagnetic fasteners and thereby retaining the ferromagnetic fastener to the tool holder magnet; placing the phalange supported tool holder adjacent to the work piece, and thereby positioning the ferromagnetic fastener adjacent to the work piece in a proper position ready to be driven into place;

and driving the ferromagnetic fastener into the work piece.

### OBJECTS OF THE INVENTION

Exemplary embodiments of the present invention solve inadequacies of the prior art by providing a generally annular tool holder that is fabricated from a relatively soft and highly elastic hypo-allergenic silicone material. A tool receptacle body protrudes radially from an annular band. The tool receptacle body has a plurality of at least partial bores that extend longitudinally along an axis parallel to the central axis of the annulus. The bores are configured to receive bits. One or more magnets may also be provided, extending the types of uses for the tool holder.

The present invention and the preferred and alternative embodiments have been developed with a number of objectives in mind. While not all of these objectives are found in every embodiment, these objectives nevertheless provide a sense of the general intent and the many possible benefits that are available from embodiments of the present invention.

A first object of the invention is to provide a comfortable and safe tool holder that may be worn upon a ring or thumb and that is configured to receive and selectively retain a plurality of drill and driver bits. A second object of the invention is to accommodate diverse diameters of bits and diverse finger sizes with no change in the tool holder. Another object of the present invention is to fabricate the tool holder as a single unitary component. A further object of the invention is to provide a tool holder that is safe to use in the immediate vicinity of both power and manual tools, even in the event of an unexpected impact or tool malfunction. Yet another object of the present invention is to provide a tool holder that has a relatively more rigid body in the vicinity of the bits and drivers, and a relatively softer and more resilient body distal thereto. An additional object of the invention is to provide a face plate well adapted to receive and display custom engraving and branding. An even further object of the invention is to provide ventilation within the annulus interior, to facilitate comfort when wearing the ring for extended periods of time.

### BRIEF DESCRIPTION OF THE DRAWINGS

The foregoing and other objects, advantages, and novel features of the present invention can be understood and appreciated by reference to the following detailed description of the invention, taken in conjunction with the accompanying drawings, in which:

FIG. 1 illustrates a first preferred embodiment tool holder designed in accord with the teachings of the present invention from perspective view, showing an exemplary use in combination with a prior art cordless drill.

FIG. 2 illustrates the first preferred embodiment tool holder of FIG. 1 from a projected view.

FIG. 3 illustrates the first preferred embodiment tool holder of FIG. 1 from a sectional view taken along section line 3′ of FIG. 2.

FIG. 4 illustrates the first preferred embodiment tool holder of FIG. 1 from a sectional view taken along section line 4′ of FIG. 3.

FIGS. 5 and 6 illustrates a preferred combination of the first preferred embodiment tool holder of FIG. 1 in further combination with several exemplary bits, from exploded and projected views, respectively.

FIG. 7 illustrates a first alternative embodiment tool holder designed in accord with the teachings of the present invention from a projected view.

FIG. 8 illustrates a second alternative embodiment tool holder designed in accord with the teachings of the present invention from a projected view.

FIG. 9 illustrates the second alternative embodiment tool holder of FIG. 8 from a sectional view taken along section line 9′ of FIG. 8.

FIG. 10 illustrates the second alternative embodiment tool holder of FIG. 8 in further combination with a nail in a starting driving or hammering position.

FIG. 11 illustrates the second alternative embodiment tool holder in further combination with a nail of FIG. 10 in a starting driving or hammering position rotated about the thumb from that of FIG. 10.

### DESCRIPTION OF THE PREFERRED EMBODIMENT

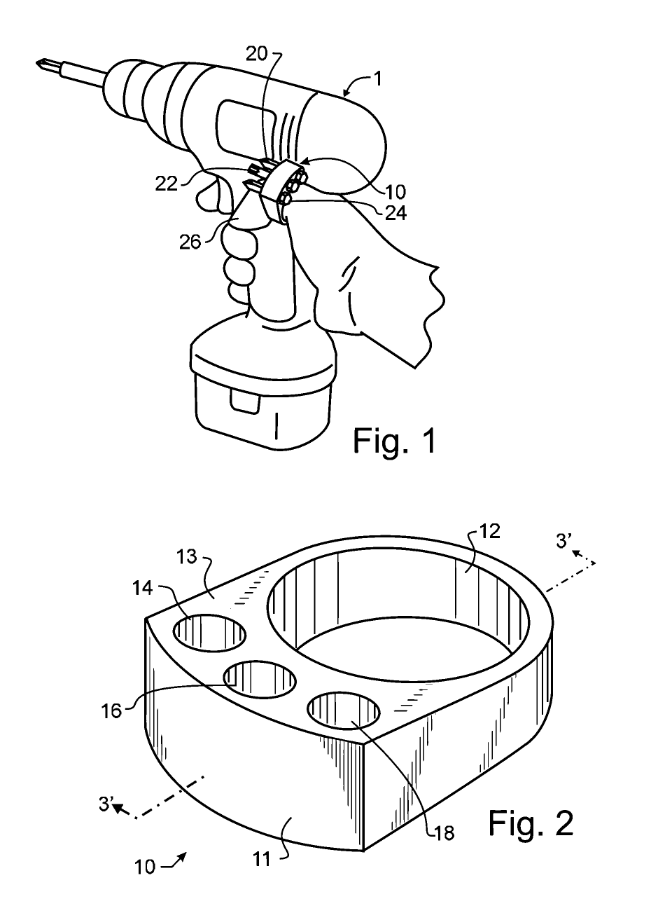

Manifested in the preferred embodiment, the present invention provides a tool holder particularly well adapted to allow a person to use a tool comfortably and unobstructed, while holding additional tools, bits, and the like conveniently around a finger or thumb. In a first preferred embodiment of the invention illustrated in FIGS. 1-6, tool holder 10 is comprised of a generally annular band 12 through which an appendage such as a person's thumb 26 as illustrated may pass.

The particular appendage that annular band 12 encircles is not essential to the invention. However, in the case of rotary tools such as drills discussed herein above, a thumb ring allows easy access to the individual bits without any interference in the handling of a drill 1 or other obstruction of the work or view thereof. FIG. 1 illustrates the combination prior art drill 1 and preferred embodiment tool holder 10.

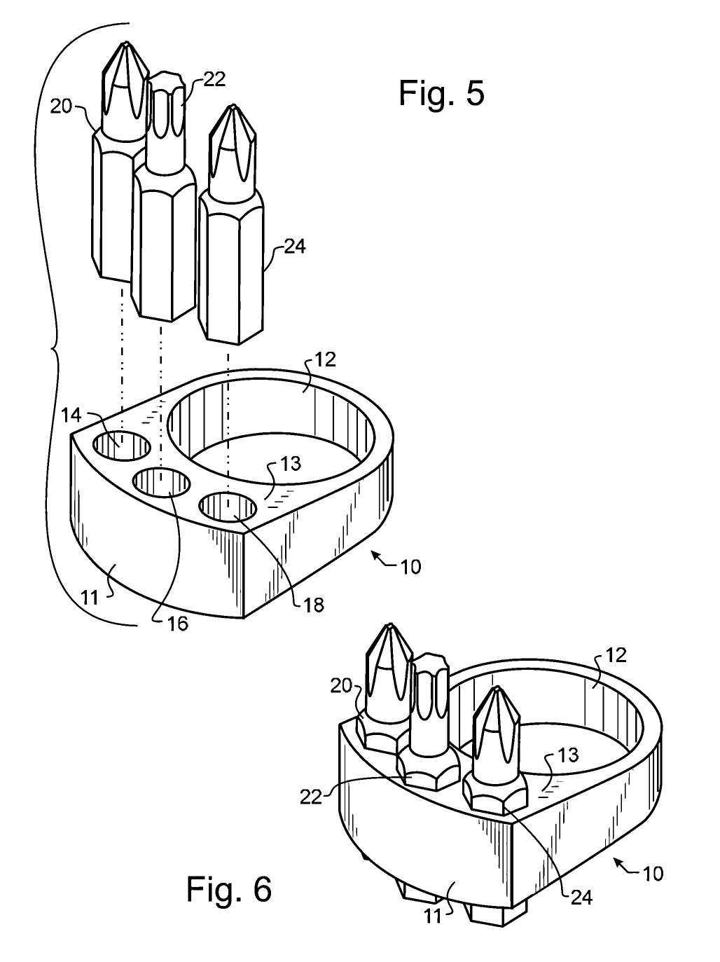

Supported by and unitary with annular band 12 is a tool receptacle body 13 protruding radially from a minority of annular band 12. Tool receptacle body 13 contains at least one tool receptacle 14, which is configured to receive and hold at least one tool bit such as bit 20 as illustrated in FIGS. 5 and 6. Most preferably, a plurality of tool receptacles such as tool receptacle 16 and tool receptacle 18 are also provided in tool receptacle body 13, so that a plurality of bits such as bit 20, bit 22, and bit 24 may be held therein. This allows a person to work with four bits at a time, with three supported in preferred embodiment tool holder 10 and one in use directly within the rotary or other tool such as drill 1. The diameter of each of tool receptacles 14-18 does not have to be identical, and so can be individually varied to suit a particular need.

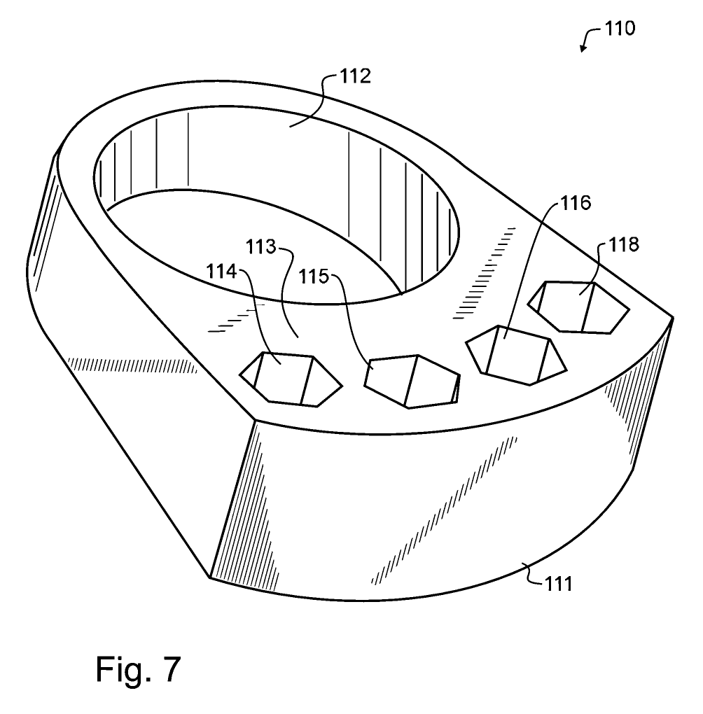

In alternative embodiments, the interior circumference of annular band 12 may be provided with facets, grooves, or other geometries that provide limited ventilation, making the ring more comfortable to wear for extended periods of time. For exemplary purposes only, and not limiting the invention solely thereto, annular band 12 may comprise a six facet interior if so desired, resembling the six facets of tool receptacles 114-118 of FIG. 7, such that there will also be six corners between the facets that provide limited ventilation. In an even further alternative embodiment, annular band 12 is also provided with radially extending bores that allow ventilation. However, the provision of radial holes complicates manufacture and can weaken the integrity of annular band 12, potentially leading to a shorter product life while providing only limited improvement in comfort.

Face plate 11 radially terminates tool receptacle body 13 distal to band 12, and provides a relatively large and only gently curved surface that will tend to be visible when in use. The visibility is apparent from the illustration of FIG. 1. Providing brand identification and custom engraving upon face plate 11 ensures repeated exposure and can greatly facilitate branding. Any suitable indicia may be provided thereon, including but not limited to trade names, trademarks, artistic works, and so forth. In a further alternative embodiment, face plate 11 may be provided with a metallic finish and optionally a corresponding color to resemble steel. In an even further embodiment, the surface may be textured to correspond to the familiar diamond metal plate pattern.

A tool holder designed in accord with the teachings of the present invention may be manufactured from a variety of materials. However, the particular selection of material can have great impact upon the utility of the resulting tool holder. Preferred embodiment tool holder 10 is fabricated from molded silicone rubber, which provides substantial elasticity to receive a variety of thumb or finger sizes, and a variety of bit diameters. In a most preferred embodiment, tool holder 10 is produced from an approximately 30 durometer hypo-allergenic silicone, most preferably medical grade. This helps to ensure that the present invention is compatible with and not irritating to most persons. The elasticity also ensures that the tool will cushion the user rather than harm them in the event of an impact, and will generally be substantially safer than a hard ring when used in the immediate vicinity of power tools. In addition, silicone offers good durability, and enables a single molding operation to produce the entire tool holder 10.

In preferred embodiment tool holder 10, annular band 12 is most preferably interminable. Interminable for the purposes of the present disclosure will be understood to mean that annular band 12 is unending and incapable of being terminated. This is in distinct contrast to much of the prior art, where various buckles split rings, or other fasteners, and open, C-shaped rings are used. The use of silicone or other highly elastic rubber ensures substantial elasticity sufficient to accommodate a very wide range of finger and thumb sizes, without requiring any adjustable straps or fasteners. The composition will also accommodate many different tool diameters and geometries. These objectives are both accomplished without requiring any change to the tool holder or to a mold used to fabricate the tool holder.

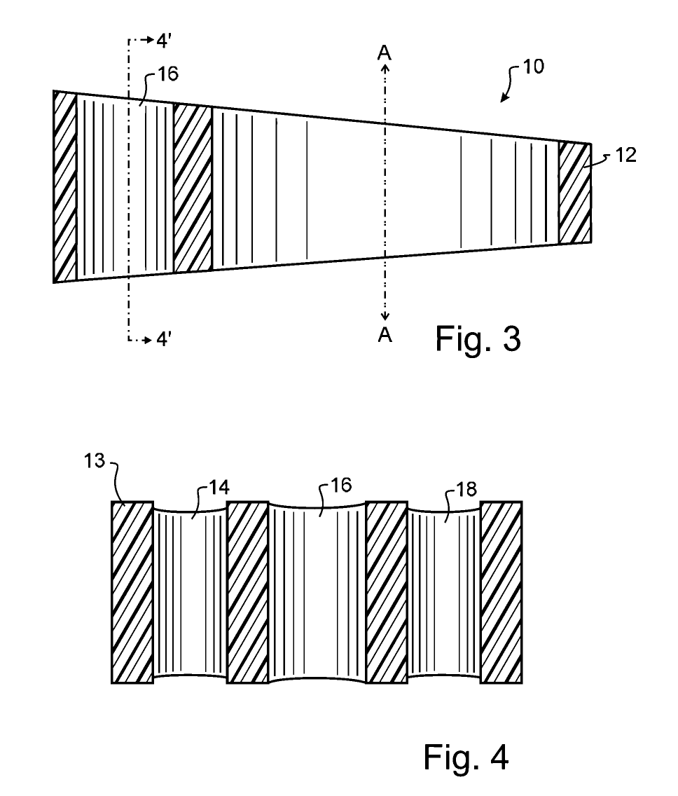

As best apparent from FIG. 3, preferred embodiment tool holder 10 is wedge-shaped from a side elevational view, being shortest in a direction parallel to the central annular axis A within band 12 most distal to tool receptacle body 13, and longest adjacent thereto. This provides several additional benefits. First, the portion of annular band 12 distal to the tool receptacle body 13 is relatively smaller and has less material bulk, making this portion more elastic, lighter, and less prone to interfering with either ventilation or the bending of an appendage. In contrast, annular band 12 adjacent to tool receptacle body 13 is relatively longer in this same direction parallel to the central annular axis A. This helps to ensure that tool receptacles 14-18 are somewhat stiffer, and will retain their generally cylindrical shape while bits are inserted or removed therefrom. In addition, the wedge geometry also helps to ensure that preferred embodiment tool holder 10 will not twist about itself, even if a bit were to stick or bind within one of the tool receptacles 14-18 during insertion or removal. By providing a wedge, rather than a discontinuous transition between annular band 12 and tool receptacle body 13, or a discontinuous transition within annular band 12, the stress during deformation will be much more evenly distributed, and will not be concentrated within any single point or region. The lack of stress concentration is important to the life expectancy and durability of preferred embodiment tool holder 10.

In addition to screwdriver bits such as slot, phillips, and star bits, other devices may also be retained within one or more of tool receptacles 14-18. For exemplary purposes, and not solely limiting the present invention thereto, this may include small pencils or other marking instruments, small punches and awls, cordless ear buds, industrial hearing protectors, and any other diverse tool or instrument for which the operator wishes quick and convenient access.

Various embodiments of apparatus designed in accord with the present invention have been illustrated in the various figures. The embodiments are distinguished by the hundreds digit, and various components within each embodiment designated by the ones and tens digits. However, many of the components are alike or similar between embodiments, so numbering of the ones and tens digits have been maintained wherever possible, such that identical, like or similar functions may more readily be identified between the embodiments. If not otherwise expressed, those skilled in the art will readily recognize the similarities and understand that in many cases like numbered ones and tens digit components may be substituted from one embodiment to another in accord with the present teachings, except where such substitution would otherwise destroy operation of the embodiment. Consequently, those skilled in the art will readily determine the function and operation of many of the components illustrated herein without unnecessary additional description.

FIG. 7 illustrates a first alternative embodiment tool holder 110. Tool receptacle body 113 has four tool receptacles including tool receptacle 114, tool receptacle 115, tool receptacle 116, and tool receptacle 118, as illustrated. As noted herein above, the particular number of tool receptacles is not essential to the invention, though three or four are preferred within tool receptacle body 113. Each of tool receptacles 114-118 are illustrated as also having a six facet interior, or hexagonal cross-section. This will directly accommodate a wide variety of standard hexagonal bits. In addition, if silicone is used as the material for fabrication, the inherent elasticity will still allow first alternative embodiment tool holder 110 to also receive and retain other geometries of tools, bits, and the like, including those that are generally cylindrical.

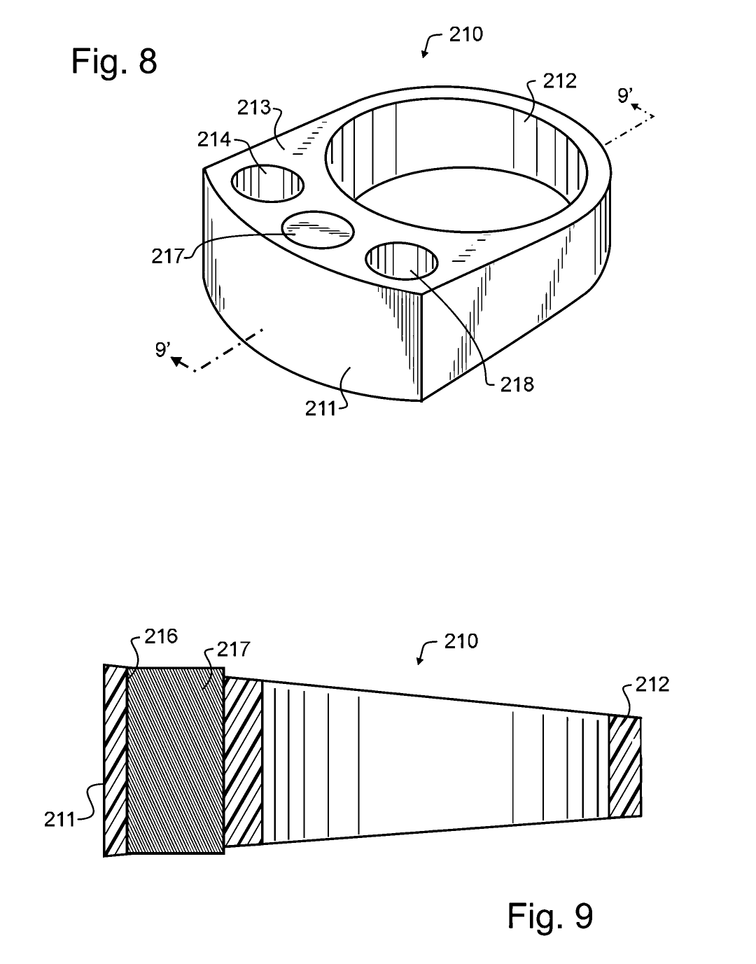

FIGS. 8 and 9 illustrate a second alternative embodiment tool holder 210. Annular band 212 provides an engagement for a person's thumb or finger, and tool receptacles 214, 218 are configured to hold various bits and tools. Various features may be used from each of the different embodiments as desired to create various different embodiments similar to but differing from the specific embodiments illustrated herein. Consequently, it will be understood that tool receptacles 214, 218 need not be cylindrical, and may be faceted such as taught by first alternative embodiment tool receptacles 114-118. In this second alternative embodiment tool holder 210, a magnetic tool receptacle 216 is preferably provided that contains a magnet 217 therein. This magnet may be molded directly into tool holder 210 at the time of fabrication, or may be inserted subsequent thereto. Magnet 217 provides diverse utility, including allowing a person to: hold diverse bits that do not fit will into tool receptacles 214, 218; readily retrieve ferromagnetic screws and nails without having to look and carefully try to grasp them; rapidly retrieve accidentally dropped ferromagnetic parts and bits; and store second alternative embodiment tool holder 210 in engagement with a ferromagnetic tool box or other ferromagnetic object when not in use.

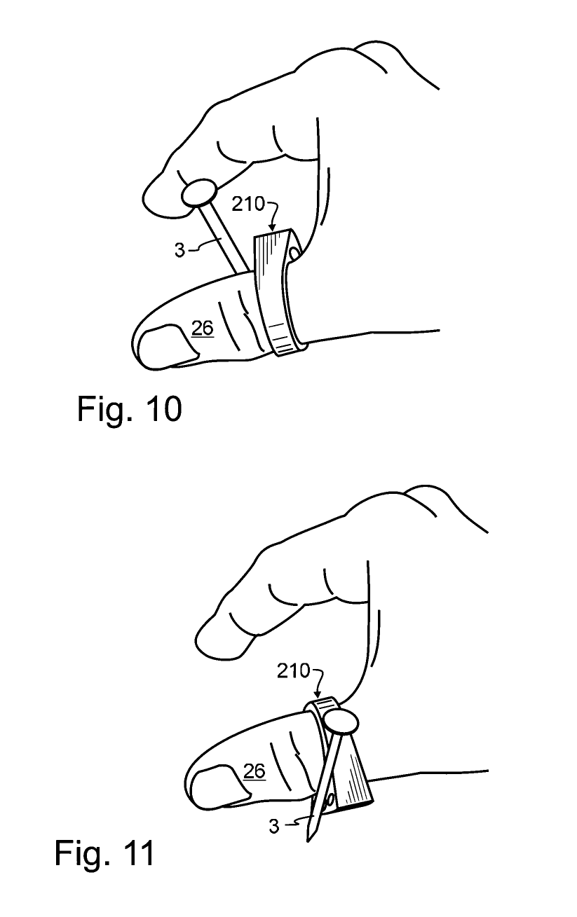

Magnet 217 is preferably positioned to work cooperatively with a person's fingers to pick up fasteners, for exemplary purposes such as screws and nails, and allow a person to hold them in proper position ready to be driven into place, potentially entirely by magnetic attraction. This is illustrated in FIGS. 10 and 11, showing nail 3 positioned to be driven into an underlying board while being held by magnetic tool receptacle 216 and magnet 217. In the illustration of FIG. 10, a person may optionally use their pointer finger to press the nail 3 or other ferromagnetic fastener against magnet 217, but as long as magnet 217 is sufficiently strong, they would likely instead only use their pointer finger to ensure proper alignment of nail 3 with respect to the underlying board, and then, as illustrated, move their pointer finger out of the way of a hammer FIG. 11 illustrates the flexibility of use of the present invention, where tool holder 210 has been rotated approximately 180 degrees about the annular axis. In this Figure, magnet 217 may be used to hold nail 3 in place, without any manipulation by a person's fingers. As can be appreciated, magnetic tool receptacle 216 thereby greatly simplifies the handling of small ferromagnetic objects such as screws, bolts, and nails.

Each of the illustrated embodiments shows the individual tool receptacles 14-18, 114-118, 214-218 as being parallel to the axis of the associated annular band 12, 112, 212. This is preferred, since the tool may be readily inserted therein, and readily viewed such as illustrated by FIG. 1 even from along the longitudinal axis of the tool receptacle openings. In addition, this simplifies the molding operation required for production. In one alternative embodiment, the tool receptacles 14-18, 114-118, 214-218 are still parallel to the axis of the associated annular band 12, 112, 212, but do not extend entirely through from one surface to another. In other alternative embodiments, one or more such tool holders or magnets may also be provided on an axis radially oriented relative to annular band 12, or on another axis offset therefrom. Such an offset tool receptacle may or may not be provided with a magnet similar to magnet 217, if so desired.

While the foregoing details what is felt to be the preferred embodiment of the invention, no material limitations to the scope of the claimed invention are intended. Further, features and design alternatives that would be obvious to one of ordinary skill in the art are considered to be incorporated herein. The scope of the invention is set forth and particularly described in the claims herein below.

I claim:

1. In combination, a rotary driver, at least one rotary driver bit, and a tool holder,
said rotary driver comprising:
a rotary drive engine;
a switch configured to selective energize said rotary drive engine; and
a rotary tool chuck configured to selectively couple and decouple said at least one rotary driver bit to said rotary driver;
said tool holder comprising:
an interminable annular band defining an annular axis and adapted to receive a thumb or finger therein;
at least one tool receptacle body affixed with and radially protruding from said annular band; and
an opening passing through said at least one tool receptacle body in an axis generally parallel to an axis defined by said annular band and configured to removably receive and retain said at least one rotary driver bit.

2. The combination rotary driver, at least one rotary driver bit, and tool holder of claim 1, wherein said interminable annular band extends least in a direction parallel to said annular axis at a location distal to said at least one tool receptacle, extends most in said direction parallel to said annular axis at a location adjacent to said at least one tool receptacle, and tapers smoothly between said locations of least and greatest extension.

3. The combination rotary driver, at least one rotary driver bit, and tool holder of claim 3, wherein said tool holder has a wedge-shaped profile from a side elevational view.

4. The combination rotary driver, at least one rotary driver bit, and tool holder of claim 1, wherein said tool holder further comprises a magnet captured within and passing through said at least one tool receptacle body in an axis generally parallel to an axis defined by said annular band.

5. The combination rotary driver, at least one rotary driver bit, and tool holder of claim 1, wherein said tool holder further comprises a face plate that terminates said tool receptacle body distal to said interminable annular band.

6. The combination rotary driver, at least one rotary driver bit, and tool holder of claim 5, wherein said face plate further comprises indicia.

7. The combination rotary driver, at least one rotary driver bit, and tool holder of claim 1, wherein said tool holder further comprises hypo-allergenic silicone rubber.

8. The combination rotary driver, at least one rotary driver bit, and tool holder of claim 7, wherein said hypo-allergenic silicone rubber further comprises a 30 durometer hardness.

9. The combination rotary driver, at least one rotary driver bit, and tool holder of claim 1, wherein said interminable annular band further comprises a means for providing limited ventilation.

10. The combination rotary driver, at least one rotary driver bit, and tool holder of claim 1, wherein said at least one tool receptacle body opening further comprises a plurality of facets.

11. The combination rotary driver, at least one rotary driver bit, and tool holder of claim 1, wherein said at least one tool receptacle body opening extends entirely through said at least one tool receptacle body from a first surface to another.

12. The combination rotary driver, at least one rotary driver bit, and tool holder of claim 1, wherein said at least one tool receptacle body opening extends through said at least one tool receptacle body from a first surface into and terminates within an interior of said at least one tool receptacle body.

13. The combination rotary driver, at least one rotary driver bit, and tool holder of claim 5, wherein said face plate further comprises a metallic finish textured with a diamond metal plate pattern.

14. The combination rotary driver, at least one rotary driver bit, and tool holder of claim 4, wherein said tool holder further comprises a second opening passing through said at least one tool receptacle body in an axis generally parallel to an axis defined by said annular band and configured to removably receive and retain said at least one rotary driver bit, said magnet located between said first and second openings.

15. A tool holder, comprising:
an interminable annular band defining an annular axis and adapted to receive a thumb or finger therein;
at least one tool receptacle body affixed with and radially protruding from said annular band; and
an opening passing through said at least one tool receptacle body in an axis generally parallel to an axis defined by said annular band and configured to removably receive and retain a rotary driver bit.

16. The tool holder of claim 15, wherein said interminable annular band extends least in a direction parallel to said annular axis at a location distal to said at least one tool receptacle, extends most in said direction parallel to said annular axis at a location adjacent to said at least one tool receptacle, and tapers smoothly between said locations of least and greatest extension.

17. The tool holder of claim 15, wherein said tool holder further comprises 30 durometer hypo-allergenic silicone rubber.

18. The tool holder of claim 15, wherein said at least one tool receptacle body opening further comprises a plurality of facets.

19. A method of applying a ferromagnetic fastener to a work piece, comprising the steps of:
inserting a phalange supported tool holder having a magnet affixed thereto into a plurality of ferromagnetic fasteners;
removing said tool holder from said plurality of ferromagnetic fasteners and thereby retaining said ferromagnetic fastener to said tool holder magnet;
placing said phalange supported tool holder adjacent to said work piece, and thereby positioning said ferromagnetic fastener adjacent to said work piece in a proper position ready to be driven into place; and
driving said ferromagnetic fastener into said work piece.

20. The method of applying a ferromagnetic fastener to a work piece of claim 19, further comprising the step of manually orienting said ferromagnetic fastener relative to said work piece subsequent to said placing step.
